(19) United States
(12) Patent Application Publication
(10) Pub. No.: US 2008/0150684 A1
(43) Pub. Date: Jun. 26, 2008

(54) Portable entry system and method

(75) Inventor: Klaus W. Gartner, Palos Verdes Estates, CA (US)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Lock Technology B.V., Torrance, CA (US)

(21) Appl. No.: 11/800,097

(22) Filed: May 4, 2007

Related U.S. Application Data
(63) Continuation-in-part of application No. 10/981,898, filed on Nov. 4, 2004, now abandoned.

(51) Int. Cl. G05B 19/00

(52) U.S. Cl. 340/5.53; 340/5.2; 345/169; 704/246

(57) ABSTRACT

A portable entry system and method is provided. The portable entry system includes an electromechanical lock used for securing a safe door to a safe housing. The system also includes a portable entry device that allows the electromechanical lock to be operated between open and closed positions. The portable entry device is removable from the electromechanical lock such that it may be programmed and recharged at a location remote from the electromechanical lock. An authorized user enters an authorized user security code that activates the portable entry device. Without an activated device, the electromechanical lock cannot be operated.

### CROSS REFERENCE TO RELATED APPLICATIONS

This application is a continuation-in-part of U.S. application Ser. No. 10/981,898, filed Nov. 4, 2004, the entirety of which is hereby incorporated by reference.

### BACKGROUND OF THE INVENTION

1. Field of the Invention

The present invention relates to a portable entry mechanism for use on a device such as a safe. More particularly, the present invention relates to an electronic portable entry mechanism that is removable from a safe or vault when not in use.

2. Description of the Related Art

Electronic locks have become a popular alternative to mechanical locks due to their versatility and security. For example, electronic locks allow a user to set their own combinations. With the increase in passwords, Personal Identification Numbers (PINs) and other codes that people need to remember, a lock combination that is set by the user allows the user to select combinations that are easy to remember.

Exemplary electronic locks are shown and described in Gartner, U.S. Pat. No. 6,786,519, and Gartner, U.S. Pat. No. 6,760,964, both incorporated by reference herein in their entireties. Electronic locks typically employ an electromagnetic device, such as a solenoid, operably connected to a circuit board. The circuit board, upon receiving a predetermined input representing the access code, sends an electrical signal to the electromagnetic device, thereby energizing the device to an “open” state and allowing the safe to be opened. These electronics are typically powered by a battery, which is either hidden in the safe door or in the keypad housing. The Gartner '519 patent discloses a keypad that includes a battery that can be replaced without opening the safe, and also provides a secure connection to internal circuitry to thwart tampering efforts and accidental breakage during assembly. The Gartner '964 patent discloses a swing bolt lock that is operably connected to a plunger-type solenoid. The plunger engages a locking plate. When the lock is in the locked condition, the locking plate engages the locking bolt to prevent the swing bolt from pivoting. When a user enters the correct combination, the plunger disengages the locking plate so that the locking plate slides out of engagement with the locking bolt. A handle connected by a shaft through the outside of the safe drives the boltworks. Movement of the boltworks acts on the swing bolt and pivots it to the unlocked position. Because the locking plate is out of engagement with the locking bolt, it does not prevent the swing bolt from pivoting thus allowing the user to access the safe.

Although the Gartner '519 and '964 patents address many of the previous shortcomings of electronic locks, it would be desirable to provide a lock that is operable with a portable entry device that contains the power supply for operating the electromechanical safe lock and that can be stored at a location remote from the lock. Further, a portable entry device that is operable only by authorized users via entry of an authorized user code and that contains a separate lock security code that mates with a code stored in a lock within a safe would also be desirable. If the portable entry device was misplaced or became lost and an unauthorized user found the portable entry device, the unauthorized user would not be able to use the device because the unauthorized user would not have the authorized user code to activate the device.

For example, automatic teller machines (“ATMs”) are typically located in public places and contain large amounts of cash. Even without an access code, an unauthorized user would have an opportunity to manipulate the keypad on the safe and open the safe. Consequently, such safes are typically hidden behind a locked cabinet, giving an additional degree of security. However, if the lock were constructed and arranged such that the keypad and power supply were removable when not in use, further security would be provided. A portable entry device including external keypad and internal power supply could be further protected in an offsite location, such as in another safe or simply carried by the authorized user. Thus, a security company tasked with emptying money from a vault could securely maintain the necessary entry device in a separate safe and check the entry device out to authorized security personnel for the limited time necessary to access the vault. Not only would the entry device avoid tampering efforts, if it were somehow lost or stolen, it would be useless without the authorized user's security code.

Furthermore, it would be desirable to provide a portable entry device that is designed so that it cannot inadvertently be left in the safe door. A device that includes this type of feature would minimize the likelihood that an authorized user will leave the safe door open; it being unlikely that the user will move on to the next destination without having the portable entry device in hand.

### SUMMARY OF THE INVENTION

The present invention relates to a portable entry device that operates an electromechanical lock inside, for example, a safe. The portable entry device is carried by the user and/or stored at a remote site when the user does not need to operate the lock in order to access the safe. This arrangement provides an added degree of security to the contents of the safe being protected by the lock.

The portable entry system in accordance with the present invention includes a hand-held, portable entry device, an electromechanical lock positioned within a safe, and a receiving receptacle positioned on the outside of a safe for receiving the portable entry device. An optional docking station is also provided. The electromechanical lock is typically positioned on the backside of a safe door and includes a circuit board and at least one electromagnetic device that is moveable or otherwise influenced by the circuit board. The portable entry device includes a pre-programmed lock security code or codes and an authorized user code or codes, a power supply therewithin, such as a battery, and a user-activated interface such as a keypad, fingerprint identification system, retina scan, voice-recognition device, electronic signature pad, or the like. Alternatively, a global positioning system may be used. If a GPS is installed in the portable entry device, the device cannot be activated unless the coordinates of the portable entry device with installed GPS match the coordinates of safe's location. The portable entry device is constructed and arranged to communicate with a circuit board within the electromechanical lock when placed in operating relationship thereto. Upon input, receipt and verification of the correct authorization code from the user into the user interface, the device is activated and communicates the pre-programmed lock security code to the microprocessor contained within the electromechanical lock positioned within the safe. If the microprocessor recognizes and matches the security code, it sends a signal to the circuit board, which in turns sends a command to the electromagnetic device. When the electromagnetic device receives the command, a plunger on the solenoid disengages the locking bolt, which locks the safe boltworks. A handle connected by a shaft through the outside of the safe is operably connected to the safe's boltworks. A user operating the safe's handle turns the handle. Movement of the handle causes the boltworks to act on the locking bolt which retracts or otherwise moves to the unlocked position thereby allowing the authorized user to open the safe. The power supply contained within the portable entry device provides the necessary electricity to not only the circuit board and user interface, but also to the electromagnetic device, which may be a solenoid or a motor. If a motor is used, the motor actuates the locking bolt to withdraw or otherwise retract from an engaged position, which locks the boltworks to an unengaged position, which allows the boltworks to move and open the safe. The present invention may be used with a variety of locking bolts such as a slide bolt, a dead bolt, a swing bolt and other locking bolts known to those skilled in the art.

One aspect of the present invention provides a lock system including a portable entry device that activates an electromechanical lock inside a safe. The electromechanical lock includes a locking bolt moveable between an open position and a closed position. The locking bolt blocks the safe's boltworks. The electromagnetic device includes an engaged state and a disengaged state, and prevents the locking bolt from being moveable to the open position when the electromagnetic device is in the engaged state. In the disengaged state, the electromagnetic device allows the locking bolt to move to the open position. A solenoid-operated plunger, such as disclosed in U.S. Pat. No. 6,786,519, is one example of such an electromagnetic device.

The electromechanical lock further includes a circuit board electronically connected to the electromagnetic device. The circuit board has computer memory attached thereto that is capable of storing one or more pre-programmed codes. A processor is also attached to the circuit board and in communication with the computer memory. The processor is capable of comparing a received code to at least one of the plurality of codes stored in the computer memory and sending a signal that causes the electromagnetic device to change between the engaged and disengaged states.

The electromechanical lock also includes at least one communication channel that allows communication between the portable entry device and the circuit board. Upon verifying that a code is received from an authorized user using the portable entry device, the circuit board sends a signal that causes the electromagnetic device to change between the engaged and disengaged states. An example of a communication channel is a conductor connecting the circuit board to an electrical contact on an external surface of the electromechanical lock. Another example of a communication channel is a radio frequency receiver or transceiver operably connected to the circuit board that controls the electromagnetic device.

Additionally, the electromechanical lock includes at least one power channel capable of transferring power from the portable entry device to the electromagnetic device.

The portable entry device has a housing with a user interface operably attached to the housing. The user interface may be a variety of devices, including but not limited to a keypad, a fingerprint, voice or retina recognition device, a global positioning system, or an electronic signature recognition pad. Each of these user interfaces has unique attributes that make it advantageous in different applications.

The portable entry device further includes a power supply contained within the housing and capable of supplying enough power to the electromechanical lock to power the circuit board and the electromagnetic device. The power is delivered to the circuit board through the power channel.

The physical relationship between the electromechanical lock and the portable entry device can be embodied in various configurations. A durable configuration includes a handheld device that is relatively rectangular in shape, an entire end of which constitutes a male coupling. A receiving receptacle positioned on the outside portion of the safe door defines a female coupling sized to receive the handheld device. When the male coupling end of the portable entry device is placed in the female coupling, electrical contacts on both components abut, establishing electrical communication therebetween.

Alternatively, the handheld device could comprise a male USB or serial connector or the like. A corresponding female port would then be found on the receiving receptacle. The receptacle then communicates via cable with the electromechanical lock. Another alternative provides a portable entry device that establishes data flow communication and power transfer with the electromechanical lock without physical contact between the two components and without the need for a receptacle. Isolation transformers are usable to transfer power without physical contact, while there are many forms of wireless data communication useable to relay code data between the portable entry device and the electromechanical lock. Another alternative provides a portable entry device that is in power and data flow communication directly with the electromechanical lock without the need for a receptacle.

Another aspect of the invention provides an optional docking station that is connectable to a computer. The docking station is constructed and arranged to receive the portable entry device and includes a charger operably connected to the power supply of the portable entry device when the portable entry device is received by the docking station. The charger is capable of charging or recharging the power supply in the handheld device.

The docking station also includes a data link capable of operably connecting the processor of the portable entry device to a computer when the portable entry device is in the docking station and the docking station is connected to a computer. The data link allows data flow communication between the computer and the processor of the portable entry device.

In an alternative embodiment, the portable entry device may be designed to operate without the need for a docking station. The portable entry device may be directly connectable to a computer capable of charging or recharging the power supply in the device.

Another aspect of the present invention provides a method of opening a safe. The method includes providing a safe having a door containing a receptacle for a portable entry device, boltworks that lock the safe's door, and an electromagnetic device contained within a safe, the electromagnetic device in communication with a lock that prevents the boltworks from being moved into a retracted position.

A portable entry device containing a pre-programmed user security code and a pre-programmed lock security code is provided. A user places the portable entry device in mating relationship with a receiving receptacle located on a safe door and enters a PIN, fingerprint identification, retinal scan, etc. If the user security code is correct, the portable entry device activates and sends a signal to a microprocessor located within the electromechanical lock. The microprocessor then determines whether the lock security code matches the code stored within the microprocessor. If the codes match, a signal is transmitted from the microprocessor to the electromagnetic device activating it and causing it to disengage the locking bolt allowing the authorized user to turn the safe handle and access the safe.

In yet another aspect of the invention, the receiving receptacle includes a locking means that attaches to the portable entry device when the entry device and the receiving receptacle are rotated from a first position to a second position to retract the locking bolt. The locking means forces the user to close and re-lock the safe before the portable entry device may be removed by the user. Thus, once the portable entry device and the receiving receptacle are rotated back to the first position, the locking means releases the portable entry device to allow the user to remove the device from the receiving receptacle without the need for the user to, for example, enter a closing code to remove the portable entry device.

### BRIEF DESCRIPTION OF THE DRAWINGS

FIG. 1 is a perspective view of an embodiment of a portable entry device of the present invention;

FIG. 2 is a perspective view of an embodiment of a docking station of the present invention;

FIG. 3 is a perspective view of the portable entry device of the present invention placed in the docking station;

FIG. 4 is a perspective view of an embodiment of an electromechanical lock of the present invention;

FIG. 5 is a perspective view of an embodiment of a safe door with a handle in an open position, the safe door including the portable entry device and electromechanical lock of the present invention.

FIGS. 6A and 6B illustrate operation of an alternative embodiment of a portable entry device of the present invention.

### DETAILED DESCRIPTION OF THE INVENTION

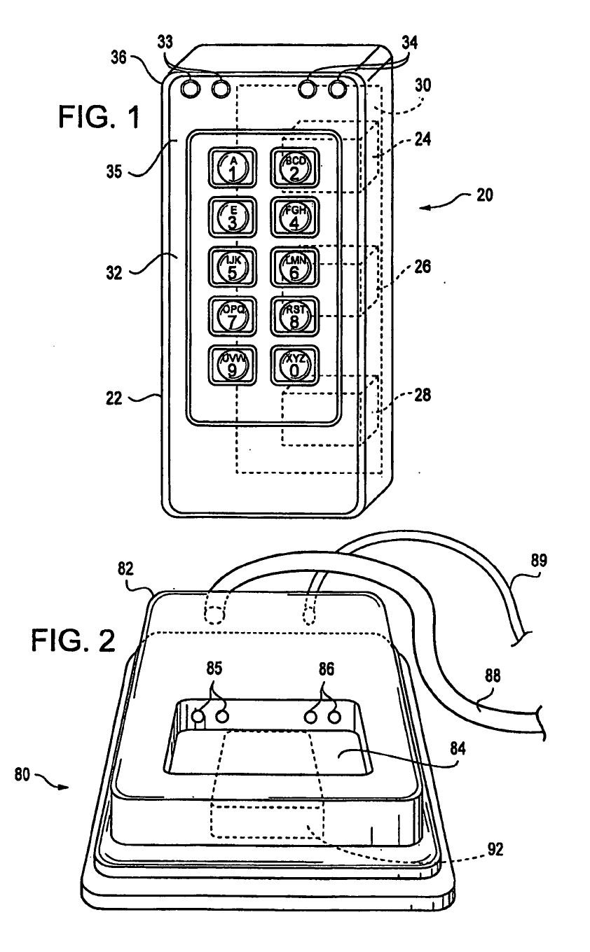

Referring now to FIGS. 1-4, it can be seen that the present invention includes a portable entry device 20; a docking station 80; an electromechanical lock 50 located within, for example, a safe; and a portable entry device receiving receptacle 64 located on, for example, the door of a safe 70. The portable entry device 20, shown in FIG. 1, includes a housing 22 that houses a microprocessor or microchip 24, computer memory 26 operably connected to the microchip 24, and a power supply 28 operably connected to the microchip 24. The internal components 24, 26 and 28 are shown schematically in phantom lines. The power supply 28 is preferably a rechargeable battery. One skilled in the art will realize that the computer memory 26 could be integrated with the microchip 24. Optimally, microchip 24 and computer memory 26 are components of a circuit board 30.

The portable entry device 20 also includes, on an outer surface, a user interface 32. The user interface 32 is operably connected to the circuit board 30 such that data flow inputted into the user interface 32 can flow to the microchip 24. The user interface 32 is embodied in FIG. 1 as a keypad. In alternative embodiments of the present invention, user interface 32 may be a fingerprint recognition or retinal scan device or other biometric devices. Also on an external surface 35 of portable entry device 20 is a plurality of contacts 33, 34. The contacts 33, 34 allow the portable entry device 20 to communicate in mating relationship with contacts 56, 57 of receptacle 64 (which in turn communicate with electromechanical lock 50) and contacts 85, 86 of docking station 80 (which in turn communicate with an external power source and a computer storing data).

Contacts 33 are in data flow communication with the microchip 24. Contacts 34 are electrically connected to the power supply 28 and usable to supply power to the electromagnetic device 54 of lock 50 when connected thereto. Contacts 34 also receive power from the docking station 80 when connected thereto during a recharging operation. As those skilled in the art will appreciate, the number of contacts for power and data communication can vary and may include one contact each or a plurality of contacts. The contacts 33, 34 shown for data flow communication and power supply are exemplary only and as those skilled in the art will appreciate may be reversed, may be on the front, back, sides or on opposites sides of the portable entry device in any usable configuration.

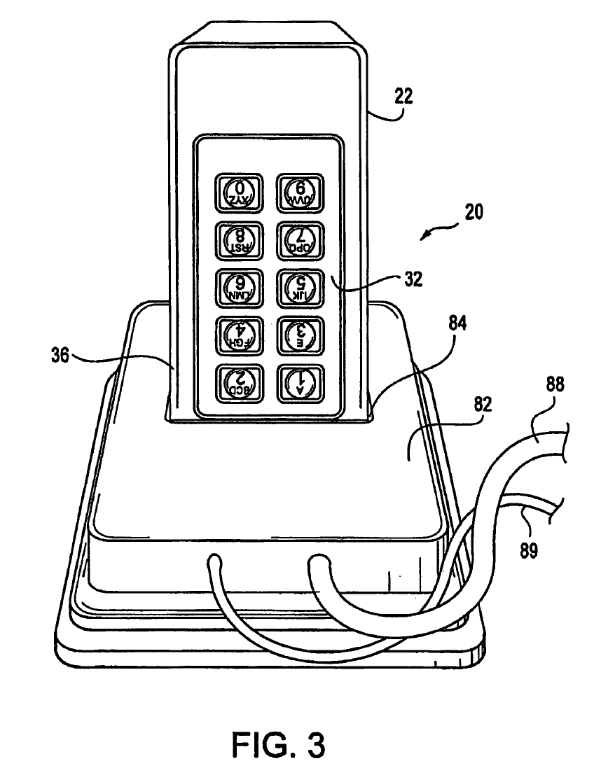

Referring now to FIG. 2, there is shown optional docking station 80 of the present invention. Docking station 80 includes a body 82 defining a receiving dock 84 sized to receive at least a portion of the portable entry device 20. The dock 84 includes data communication and power contacts 85, 86, respectively. The docking station 80 further includes a data link 88 capable of connecting the docking station 80 to a computer. The data link 88 may terminate with a universal serial bus (USB) connector, fire wire connector, or any connector usable to connect an external device to a computer. The computer may store useful information that is uploaded to the portable entry device when the portable entry device is docked in the docking station 80. For example, useful data such as the authorized users for the portable entry device, the events that transpired during, for instance, a cash-carrier route such as time of lock openings and the personnel associated with the openings may be uploaded.

The docking station 80 has a charging function and a data communications function. The charging function is used to recharge the power supply 28 of the portable entry device 20 when the portable entry device 20 is placed in the dock 84. When placed in the receiving dock 84, the contacts 34 of the portable entry device 20 are electrically connected to the contacts 86 of the docking station 80. At least one of contacts 86 supplies charging power to the power supply 28 of the portable entry device 20. Again, those skilled in the art will appreciate that the number of contacts can be varied without sacrificing functionality. Power cable 89 connects to an external power supply to maintain docking station 80 fully charged.

Those skilled in the art will also appreciate that the charging function can be accomplished by a charger 92 within the docking station 80, or may be supplied by a charger contained within the computer leaving the docking station to serve only as a connector between the power supplied by the computer and the power supply 28. If the charger 92 is contained within the docking station 80 it may receive electricity from the computer or an external source.

The data communications function establishes data flow between a external computer and microchip 24 of portable entry device 20 via data link 88. The data flow is preferably two-way flow allowing the computer to input new codes into the portable entry device 20 as well as receive data from the microchip 24 for purposes of record keeping.

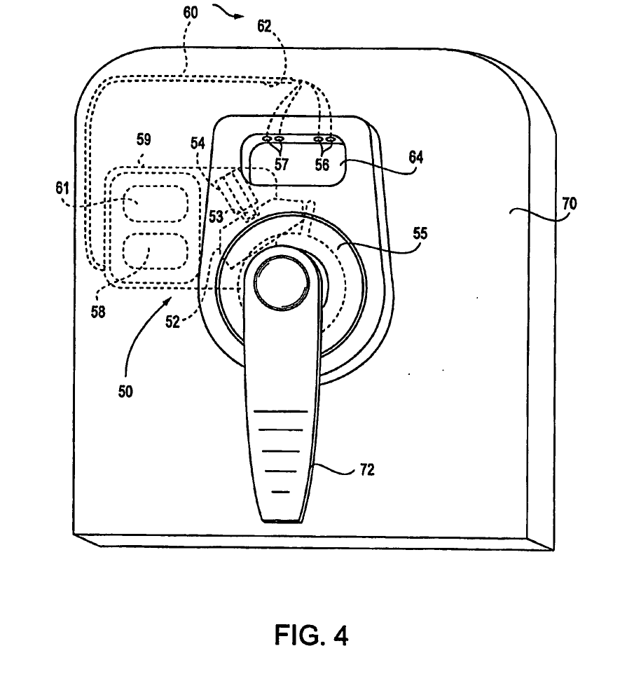

FIG. 3 depicts the portable entry device of the present invention docked in docking station 80 with power contacts 34 in communication with contact 86 and data communication contacts 33 in data flow communication with communication contacts 85.

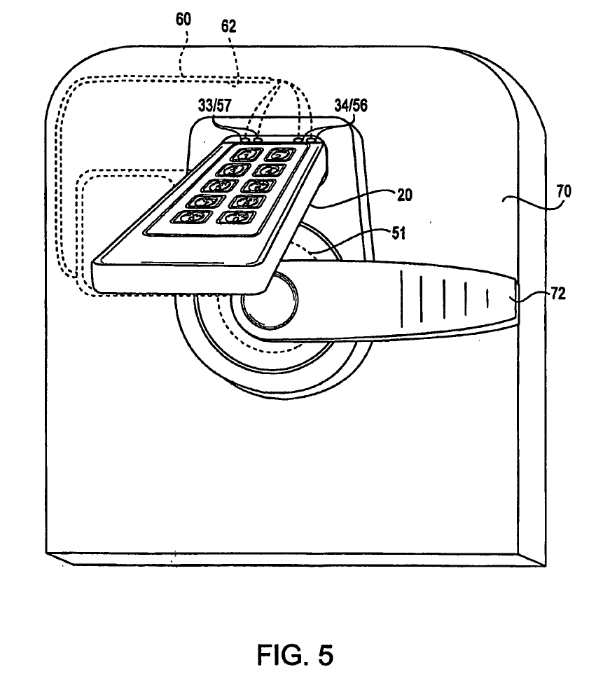

Referring now to FIG. 4, there is shown the second and third components of the present invention, an electromechanical lock 50 and a portable entry device receiving receptacle 64. The electromechanical lock 50 includes a locking bolt 52, which retracts or otherwise moves between an open position and a closed position by operation of an electromagnetic element 54, discussed in detail below. The electromechanical lock 50 could be any mechanical lock mechanism such as the swing bolt lock disclosed in U.S. Pat. No. 6,786,519 to Gartner. Alternatively, the lock mechanism may be a slide bolt, a dead bolt and other locking bolts known to those skilled in the art.

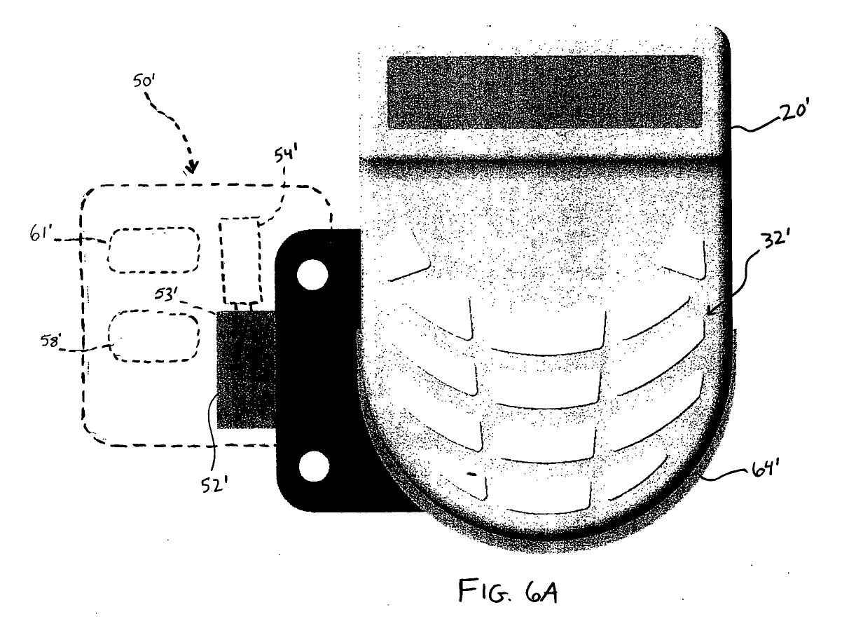

Electromechanical lock 50 includes an electromagnetic device 54, shown diagrammatically in phantom lines as an exemplary solenoid-operated plunger, which has an engaged state and a disengaged state. The electromagnetic element 54 may be a solenoid, which is a linear electromagnetic device. A motor or other rotary electromagnetic device may also be employed. A plunger 53 on the solenoid engages locking bolt 52. When the locking bolt 52 is in its locked position, it engages boltworks 55 and prevents boltworks from moving. The electromagnetic lock 50 is operably attached to the safe's boltworks 55, such that the boltworks 51 are prevented from being movable between an open position and a closed position when the electromagnetic lock 50 is in an engaged state. In the disengaged state, the electromagnetic lock 50 allows a user to rotate handle 72 on safe 70 into an open position, as shown in FIG. 5.

Receiving receptacle 64 includes a plurality of contacts 56, 57 that are positioned to electrically interact with the contacts 34, 35 of the portable entry device 20, respectively. It can be seen in FIG. 4, that the receiving receptacle 64 is configured to mate with the portable entry device 20 of FIG. 1. Receptacle 64 that is sized to receive housing 22 of the portable entry device 20. Thus, receptacle 64 constitutes a female coupling and the end 36 proximate the contacts 33, 34 of the portable entry device 20 constitutes a male coupling.

Contacts 56, 57 are electrically connected to a microchip 58. The microchip or processor 58 is a component of a circuit board 59 that is either contained within the electromechanical lock 50 or contained within the safe that the lock 50 is securing. Also on the circuit board is computer memory 61, accessible by the microchip 58. The circuit board 59 is electrically connected to at least one of the contacts 57 to form a communications channel 60 therebetween. Furthermore, the circuit board 59 is electrically connected to at least one of the contacts 56 to form a power channel therebetween. The power channel 62 further connects the circuit board 59 to the electromagnetic device 54.

In operation, the portable entry device 20 is stored in docking station 80 where data is uploaded into computer memory 26 of microprocessor 24. The stored data may include information such as any number of authorized user codes, any number of security codes that correspond to safes located along a carrier's route, the events that transpired during a cash-carrier route such as time of safe openings and the personnel associated with the openings. Upon arriving at a safe's location, the user would typically first place the portable entry device 20 in the receiving receptacle 64 located on safe door 70. Contacts 33 and 34 are placed in communication with contacts 57 and 56, respectively and power communication and data communication is established. The user then enters his authorized user security code (or scans his retina or applies his fingerprint) into the user interface 32 of the portable entry device 20. If the user security code, retina or fingerprint matches the pre-programmed information stored within the portable entry device 20, the portable entry device is activated. Data communications channel 60 in operating communication with contact 33 relays the pre-programmed lock security code that is stored within the portable entry device 20 to microprocessor 58. Upon receiving the code, microprocessor 58 compares the received lock security code to the lock security code stored in memory 61. If the codes match, microprocessor 58 sends a signal to the electromagnetic device 54. Use of the power channel 62 may be obviated or combined with the communications channel 60 in the event that the voltage required to operate the electromagnetic device 54 is sufficiently small to be drawn from the communications channel. Upon receiving a signal from the microprocessor 58, solenoid 54 causes plunger 53 to retract thereby disengaging locking bolt 52. In an alternative embodiment, a motor (not shown) causes a locking bolt to slide, retract or otherwise move thereby disengaging the locking bolt. The user receives an audible signal indicating that the safe may be opened. The user operates handle 72, turning it to the unlocked position. Because the locking bolt 52 is disengaged, handle 72 causes the boltworks to act on the locking bolt and locking bolt retracts, pivots, slides or otherwise moves permitting boltworks 51 to freely move into the open position as shown in FIG. 5.

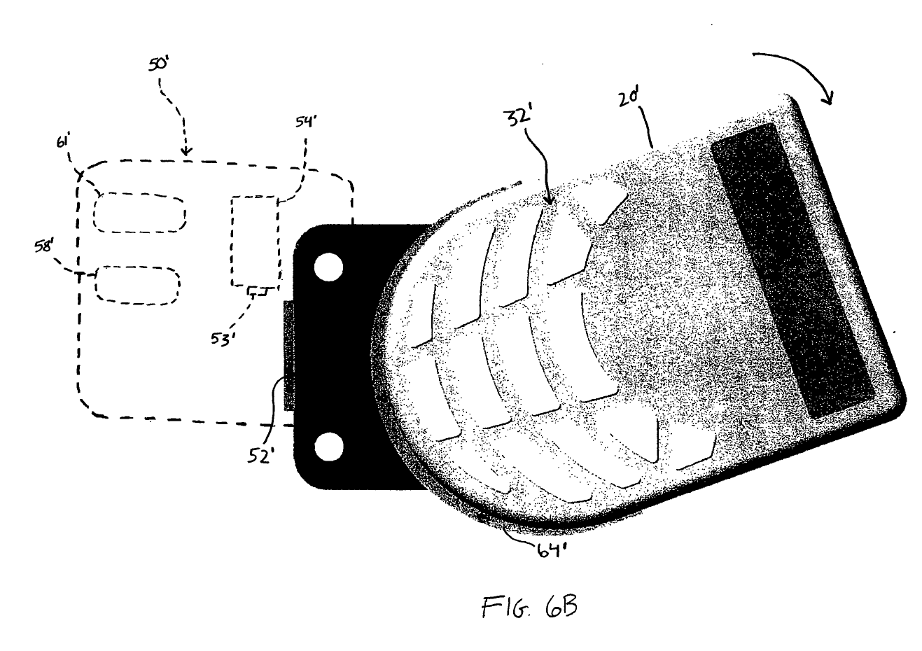

FIGS. 6A and 6B illustrate operation of an alternative embodiment of a portable entry system in accordance with the present invention, which includes portable entry device 20′, electromechanical lock 50′, and receiving receptacle 64′. In particular, FIG. 6A illustrates portable entry device 20′ and receiving receptacle 64′ in a first position corresponding to locking bolt 52′ in a locked position, while FIG. 6B illustrates portable. entry device 20′ and receiving receptacle 64′ rotated clockwise to a second position corresponding to locking bolt 52′ in an unlocked position.

Upon arriving at a safe's location, the user would place portable entry device 20′ in receiving receptacle 64′. The user then enters his authorized user security code into user interface 32′ (or via any of the alternative methods previously described). If the user security code matches the pre-programmed information stored within portable entry device 20′, the portable entry device is then activated. The pre-programmed lock security code in portable entry device 20′ is then relayed to microprocessor 58′, which compares the received lock security code to the lock security code stored in memory 61′. If the security codes match, microprocessor 58′ sends a signal to electromagnetic device 54′, thereby retracting or moving plunger 53′ and disengaging locking bolt 52′. As those skilled in the art will appreciate, electromagnetic device 54′ may comprise a motor which would rotate a rotary disk.

The user then rotates portable entry device 20′ and receiving receptacle 64′ from the first position to the second position as illustrated in FIG. 6B. As a result, because locking bolt 52′ is disengaged from plunger 53′, rotating portable entry device 20′ to the second position causes the boltworks (not shown) to act on the locking bolt and the locking bolt retracts, pivots, slides, or otherwise moves permitting the boltworks to freely move into the open position.

When portable entry device 20′ and receiving receptacle 64′ are in the second position illustrated in FIG. 6B, the entry device may not be removed from the receiving receptacle. In particular, receiving receptacle 64′ includes a locking means that attaches to portable entry device 20′ when the entry device and the receiving receptacle are rotated to the second position to retract locking bolt 52′. The locking means forces the user to close and re-lock the safe before portable entry device 20′ may be removed by the user. Thus, once portable entry device 20′ and receiving receptacle 64′ are rotated back to the first position as shown in FIG. 6A, the locking means releases portable entry device 20′ to allow the user to remove the device from receiving receptacle 64′ without the need for the user to, for example, enter a closing code to remove the portable entry device.

It is contemplated that features disclosed in this application can be mixed and matched to suit particular circumstances. Various other modifications and changes will be apparent to those of ordinary skill in the art without departing from the spirit and scope of the present invention. Accordingly, reference should be made to the claims to determine the scope of the present invention.

What is claimed is:

1. A portable entry system comprising:
(a) an electromechanical lock comprising:
a locking bolt moveable between an open position and a closed position;
an electromagnetic device having an engaged state and a disengaged state, the electromagnetic device operably attached to the locking bolt for preventing the locking bolt from being moveable to the open position when the electromagnetic device is in the engaged state, and allowing the locking bolt to be moveable to the open position when the electromagnetic device is in the disengaged state;
a circuit board electronically connected to the electromagnetic device;
computer memory attached to the circuit board capable of storing at least one lock security code;
a processor attached to the circuit board and in communication with the computer memory, the processor capable of comparing a received lock security code to the at least one lock security code stored in the computer memory and capable of sending a signal that causes the electromagnetic device to change between the engaged state and the disengaged state;
at least one communications channel capable of sending a code to the processor; and
at least one power channel in electrical communication with the circuit board; and
(b) a receiving receptacle including at least one power contact and at least one data communications contact, the at least one power contact operably connected to the at least one power channel and the at least one data communications contact operably connected to the at least one communications channel;
(c) a portable entry device removably detachable from the receiving receptacle, the portable entry device comprising:
a housing including at least one data communications contact and at least one power communications contact;
a power supply contained within the housing, the power supply in operating communication with the at least one power communications contact;
a processor contained within the housing having computer memory in operating communication with the at least one data communication contact, the computer memory storing an authorized user security code and the lock security code;
a user interface operably attached to the housing and in operating communication with communications channel;
wherein when the portable entry device is placed in the receiving receptacle, the at least one data communications contact and the at least one power communications contact are in operating relationship with the communications channel and power channel such that when an authorized user enters the authorized user security code in the user interface, the portable entry device microprocessor transmits the lock security code stored in the portable entry device to the electromechanical lock microprocessor for comparison, and
further wherein if the lock security code received from the portable entry device matches the lock security code stored in the electromechanical lock, the electromechanical lock processor sends a signal to the circuit board causing the electromagnetic device to change from the engaged state to the disengaged state;
(d) a handle member moveable from a first position to a second position after the electromagnetic device has changed to the disengaged state to move the locking bolt from the closed position to the open position.

2. The portable entry system of claim 1 further comprising a docking station operably connectable to a computer, the docking station constructed and arranged to receive the portable entry device.

3. The portable entry system of claim 2 wherein the docking station further comprises:
a charger operably connected to the power supply of the portable entry device when the portable entry device is received by the docking station, the charger capable of charging the power supply; and
a data link capable of operably connecting the processor of the portable entry device to the computer, when the portable entry device is received by the docking station and the docking station is connected to the computer thereby allowing data flow communication between the computer and the processor of the portable entry device.

4. The portable entry system of claim 1 wherein the locking bolt comprises a bolt selected from the group consisting of a swing bolt, a slide bolt, or a deadbolt.

5. The portable entry system of claim 1 wherein the electromagnetic device comprises a solenoid operated plunger.

6. The portable entry system of claim 1 wherein the electromagnetic device comprises a motor.

7. The portable entry system of claim 1 wherein the at least one communication channel comprises at least one electrical contact.

8. The portable entry system of claim 1 wherein the at least one power channel comprises at least one electrical contact.

9. The portable entry system of claim 1 wherein the user interface comprises a keypad.

10. The portable entry system of claim 1 wherein the user interface comprises a fingerprint recognition device.

11. The portable entry system of claim 1 wherein the user interface comprises a retina recognition device.

12. The portable entry system of claim 1 wherein the user interface comprises a global positioning system.

13. The portable entry system of claim 1 wherein the user interface comprises a voice recognition device.

14. The portable entry system of claim 1 wherein the user interface comprises an electronic signature recognition pad.

15. The portable entry system of claim 1 wherein the housing of the portable entry device is configured to mate with the receiving receptacle such that when mated, the power supply of the portable entry device in electrically connected to the power channel and the portable entry device processor is in data flow communication with the communication channel.

16. The portable entry system of claim 1 wherein the receiving receptacle comprises a female coupling and the portable entry device comprises a male coupling configured to mate with the female coupling, the male and female coupling constructed and arranged such that when mated, the power supply of the portable entry device is electrically connected to the power channel and the portable entry device processor is in data flow communication with the communication channel.

17. The portable entry system of claim 16 wherein the male coupling of the portable entry device comprises a portion of the housing of the portable entry device.

18. The portable entry system of claim 1 wherein the portable entry device comprises a handheld device.

19. A method of opening a lock comprising:
providing a portable handheld device including a pre-programmed authorized user security code and a lock security code;
placing the activated handheld device in data flow communication with an electromechanical lock engageable with a locking bolt;
entering an authorized user code into the handheld device to activate the portable handheld device;
sending a signal to a microprocessor positioned within the electromechanical lock;
determining whether the lock security code matches a lock security code stored within the lock and if matched;
causing the electromagnetic device to operate, thereby disengaging the locking bolt; and
rotating a handle member to initiate movement of the locking bolt between a closed position and an open position.

20. The method of claim 19 wherein placing the handheld device in data flow communication with the electromechanical lock comprises mating the portable handheld device with a receiving receptacle.

21. The method of claim 19 wherein entering an authorized user code into the portable handheld device comprises operating a keypad on the handheld device.

22. The method of claim 19 wherein entering an authorized user code into the handheld device comprises scanning a fingerprint into the handheld device.

23. The method of claim 19 wherein entering an authorized user code into the handheld device comprises speaking to a voice recognition device on the handheld device.

24. The method of claim 19 wherein entering an authorized user code into the handheld device comprises receiving a signal into the handheld device from a global positioning satellite.

25. The method of claim 19 wherein entering an authorized user code into the handheld device comprises scanning a retina into the handheld device.

26. The method of claim 19 wherein entering an authorized user code into the handheld device comprises signing a signature onto a signature recognition pad on the handheld device.

27. A portable entry system comprising:
a first means, attached to a first object and moveable between a first position and a second position, for creating an interference between the first object and a second object in the first position and removing interference between the first object and the second object in the second position;
a second means for restricting access to the movement of the first means between the first position and the second position, the second means being attachable to and removable from the first means.

28. A portable entry system comprising:
(a) an electromechanical lock comprising:
(i) a locking bolt moveable between an open position and a closed position;
(ii) an electromagnetic device with an engaged state and a disengaged state, the electromagnetic device operably attached to the locking bolt for preventing the locking bolt from being moveable to the open position when the electromagnetic device is in the engaged state, and allowing the locking bolt to be moveable to the open position when the electromagnetic device is in the disengaged state;
(iii) a circuit board electronically connected to the electromagnetic device;
(iv) computer memory attached to the circuit board capable of storing at least one code;
(v) a processor attached to the circuit board and in communication with the computer memory, the processor capable of comparing a received code to the at least one code stored in the computer memory and sending a signal that causes the electromagnetic device to change between the engaged and disengaged states;
(vi) at least one communication channel capable of sending a code to the processor; and
(vii) at least one power channel in electrical communication with the circuit board;
(b) a portable entry device in data and power communication with the electromechanical lock, the portable entry device comprising:
(i) a housing;
(ii) a user interface operably attached to the housing and operably connectable to the communications channel of the electromechanical lock such that when connected, a code inputted into the user interface is transmitted to the processor for comparison to the at least one code stored in the computer memory; and
(iii) a power supply contained within the housing and capable of supplying enough power to the circuit board and the electromagnetic device through the power channel to cause the electromagnetic device to change from the engaged state to the disengaged state; and
(c) a handle member moveable from a first position to a second position after the electromagnetic device has changed to the disengaged state to move the locking bolt from the closed position to the open position.

29. The portable entry system of claim 28 further comprising a docking station operably connectable to a computer, the docking station constructed and arranged to receive the portable entry device.

30. The lock system of claim 29 wherein the docking station comprises:
a charger operably connected to the power supply of the portable entry device when the portable entry device is received by the docking station, the charger capable of charging the power supply; and
a data link capable of operably connecting the processor of the portable entry device to the computer, when the portable entry device is received by the docking station and the docking station is connected to the computer thereby allowing data flow communication between the computer and the processor of the portable entry device.

31. The lock system of claim 28 wherein the locking bolt comprises a bolt selected from the group consisting of a swing bolt, a slide bolt, and a deadbolt.

32. The portable entry system of claim 28 wherein the electromagnetic device comprises a solenoid operated plunger.

33. The portable entry system of claim 28 wherein the electromagnetic device comprises a motor.

34. The portable entry system of claim 28 wherein the at least one communication channel comprises at least one electrical contact.

35. The portable entry system of claim 28 wherein the at least one power channel comprises at least one electrical contact.

36. The portable entry system of claim 28 wherein the user interface comprises a keypad.

37. The portable entry system of claim 28 wherein the user interface comprises a fingerprint recognition device.

38. The portable entry system of claim 28 wherein the user interface comprises a retina recognition device.

39. The portable entry system of claim 28 wherein the user interface comprises a global positioning system.

40. The portable entry system of claim 28 wherein the user interface comprises a voice recognition device.

41. The portable entry system of claim 28 wherein the user interface comprises an electronic signature recognition pad.

42. The portable entry system of claim 28 wherein the housing of the portable entry device is configured to mate with the electro-mechanical lock such that when mated, the power supply of the portable entry device in electrically connected to the power channel and the processor is in data flow communication with the communication channel.

43. The portable entry system of claim 28 wherein the electromechanical lock includes a female coupling and the portable entry device comprises a male coupling configured to mate with the female coupling, the male and female coupling constructed and arranged such that when mated, the power supply of the portable entry device in electrically connected to the power channel and the processor is in data flow communication with the communication channel.

44. The lock system of claim 43 wherein the male coupling of the portable entry device comprises a portion of the housing of the portable entry device.

45. The lock system of claim 28 wherein the portable entry device comprises a handheld device.

46. A portable entry system comprising:
(a) an electromechanical lock comprising:
a locking bolt moveable between an open position and a closed position;
an electromagnetic device having an engaged state and a disengaged state, the electromagnetic device operably attached to the locking bolt for preventing the locking bolt from being moveable to the open position when the electromagnetic device is in the engaged state, and allowing the locking bolt to be moveable to the open position when the electromagnetic device is in the disengaged state;
a circuit board electronically connected to the electromagnetic device;
computer memory attached to the circuit board capable of storing at least one lock security code;
a processor attached to the circuit board and in communication with the computer memory, the processor capable of comparing a received lock security code to the at least one lock security code stored in the computer memory and capable of sending a signal that causes the electromagnetic device to change between the engaged state and the disengaged state;
at least one communications channel capable of sending a code to the processor; and
at least one power channel in electrical communication with the circuit board; and
(b) a receiving receptacle including at least one power contact and at least one data communications contact, the at least one power contact operably connected to the at least one power channel and the at least one data communications contact operably connected to the at least one communications channel;
(c) a portable entry device removably detachable from the receiving receptacle, the portable entry device comprising:
a housing including at least one data communications contact and at least one power communications contact;
a power supply contained within the housing, the power supply in operating communication with the at least one power communications contact;
a processor contained within the housing having computer memory in operating communication with the at least one data communication contact, the computer memory storing an authorized user security code and the lock security code;
a user interface operably attached to the housing and in operating communication with communications channel;
wherein when the portable entry device is placed in the receiving receptacle, the at least one data communications contact and the at least one power communications contact are in operating relationship with the communications channel and power channel such that when an authorized user enters the authorized user security code in the user interface, the portable entry device microprocessor transmits the lock security code stored in the portable entry device to the electromechanical lock microprocessor for comparison,
wherein if the lock security code received from the portable entry device matches the lock security code stored in the electromechanical lock, the electromechanical lock processor sends a signal to the circuit board causing the electromagnetic device to change from the engaged state to the disengaged state, and
further wherein the portable entry device is moveable from a first position in which the portable entry device is removable from the receiving receptacle to a second position in which the portable entry device is locked to the receiving receptacle after the electromagnetic device has changed to the disengaged state to move the locking bolt from the closed position to the open position.

47. The portable entry system of claim 46 wherein the locking bolt comprises a bolt selected from the group consisting of a swing bolt, a slide bolt, or a deadbolt.

48. The portable entry system of claim 46 wherein the electromagnetic device comprises a solenoid operated plunger.

49. The portable entry system of claim 46 wherein the electromagnetic device comprises a motor.

50. The portable entry system of claim 46 wherein the user interface comprises a keypad.

51. The portable entry system of claim 46 wherein the user interface comprises a fingerprint recognition device.

52. The portable entry system of claim 46 wherein the user interface comprises a retina recognition device.

53. The portable entry system of claim 46 wherein the user interface comprises a global positioning system.

54. The portable entry system of claim 46 wherein the user interface comprises a voice recognition device.

55. The portable entry system of claim 46 wherein the user interface comprises an electronic signature recognition pad.

56. The portable entry system of claim 46 wherein the housing of the portable entry device is configured to mate with the receiving receptacle such that when mated, the power supply of the portable entry device in electrically connected to the power channel and the portable entry device processor is in data flow communication with the communication channel.

57. The portable entry system of claim 46 wherein the portable entry device comprises a handheld device.

58. A method of opening a lock comprising:
providing a portable handheld device including a pre-programmed authorized user security code and a lock security code;
placing the activated handheld device in data flow communication with an electromechanical lock engageable with a locking bolt;
entering an authorized user code into the handheld device to activate the portable handheld device;
sending a signal to a microprocessor positioned within the electromechanical lock;
determining whether the lock security code matches a lock security code stored within the lock and if matched;
causing the electromagnetic device to operate, thereby disengaging the locking bolt; and
rotating the handheld device to initiate movement of the locking bolt between a closed position and an open position.

59. The method of claim 58 wherein placing the handheld device in data flow communication with the electromechanical lock comprises mating the portable handheld device with a receiving receptacle.

60. The method of claim 59 wherein rotating the handheld device to initiate movement of the locking bolt comprises rotating the handheld device from a first position in which the handheld device is removable from the receiving receptacle to a second position in which the handheld device is locked to the receiving receptacle.

61. The method of claim 58 wherein entering an authorized user code into the portable handheld device comprises operating a keypad on the handheld device.

62. The method of claim 58 wherein entering an authorized user code into the handheld device comprises scanning a fingerprint into the handheld device.

63. The method of claim 58 wherein entering an authorized user code into the handheld device comprises speaking to a voice recognition device on the handheld device.

64. The method of claim 58 wherein entering an authorized user code into the handheld device comprises receiving a signal into the handheld device from a global positioning satellite.

65. The method of claim 58 wherein entering an authorized user code into the handheld device comprises scanning a retina into the handheld device.

66. The method of claim 58 wherein entering an authorized user code into the handheld device comprises signing a signature onto a signature recognition pad on the handheld device.

67. A portable entry system comprising:
(a) an electromechanical lock comprising:
(i) a locking bolt moveable between an open position and a closed position;
(ii) an electromagnetic device with an engaged state and a disengaged state, the electromagnetic device operably attached to the locking bolt for preventing the locking bolt from being moveable to the open position when the electromagnetic device is in the engaged state, and allowing the locking bolt to be moveable to the open position when the electromagnetic device is in the disengaged state;
(iii) a circuit board electronically connected to the electromagnetic device;
(iv) computer memory attached to the circuit board capable of storing at least one code;
(v) a processor attached to the circuit board and in communication with the computer memory, the processor capable of comparing a received code to the at least one code stored in the computer memory and sending a signal that causes the electromagnetic device to change between the engaged and disengaged states;
(vi) at least one communication channel capable of sending a code to the processor; and
(vii) at least one power channel in electrical communication with the circuit board; and
(b) a portable entry device in data and power communication with the electromechanical lock, the portable entry device comprising:
(i) a housing;
(ii) a user interface operably attached to the housing and operably connectable to the communications channel of the electromechanical lock such that when connected, a code inputted into the user interface is transmitted to the processor for comparison to the at least one code stored in the computer memory; and
(iii) a power supply contained within the housing and capable of supplying enough power to the circuit board and the electromagnetic device through the power channel to cause the electromagnetic device to change from the engaged state to the disengaged state;
(iv) wherein the portable entry device is moveable from a first position to a second position after the electromagnetic device has changed to the disengaged state to move the locking bolt from the closed position to the open position.

68. The portable entry system of claim 67 wherein the portable entry device is removable from the receiving receptacle in the first position and wherein the portable entry device is locked to the receiving receptacle in the second position.
